(19) United States
(12) Patent Application Publication
(10) Pub. No.: US 2025/0110479 A1
(43) Pub. Date: Apr. 3, 2025

(54) TECHNIQUES FOR CONTROLLING AN AREA

(71) Applicant: Apple Inc., Cupertino, CA (US)

(72) Inventor: Siji Rachel TOM, Sunnyvale, CA (US)

(21) Appl. No.: 18/896,009

(22) Filed: Sep. 25, 2024

Related U.S. Application Data
(60) Provisional application No. 63/541,812, filed on Sep. 30, 2023.

(51) Int. Cl. G05B 19/4155; G06F 3/0484

(52) U.S. Cl. CPC G05B 19/4155; G05B 2219/25011; G06F 3/0484

(57) ABSTRACT

The present disclosure generally relates to techniques for controlling an area.

### CROSS-REFERENCE TO RELATED APPLICATIONS

This application claims priority to U.S. Patent Application No. 63/541,812, entitled “TECHNIQUES FOR CONTROLLING AN AREA,” filed Sep. 30, 2023, the entire contents of which are hereby incorporated by reference.

### FIELD

The present disclosure relates generally to techniques for controlling an area.

### BACKGROUND

Users can access various types of areas such as buildings, platforms, vehicles, and portions thereof. Areas can include systems and accessories that can be controlled.

### SUMMARY

Some techniques for controlling an area using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for controlling an area. Such methods and interfaces optionally complement or replace other methods for controlling an area. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: detecting that a set of one or more proximity conditions is satisfied, wherein the set of one or more proximity conditions includes a distance condition that is satisfied when a distance between a computer system and an area is determined to satisfy a threshold distance; in response to detecting that the set of one or more proximity conditions is satisfied, displaying a prompt to open an area control application that is configured to perform one or more functions associated with the area; while displaying the prompt to open the area control application, detecting an input that includes selection of the prompt; in response to detecting the input that includes selection of the prompt, displaying a user interface of the area control application, including displaying, in the user interface of the area control application, one or more selectable elements including an area control element; detecting an input that includes selection of the area control element; and in response to detecting the input that includes selection of the area control element, requesting that the area perform an operation corresponding to the area control element.

In accordance with some embodiments, a non-transitory computer-readable storage medium is described. The non-transitory computer-readable storage medium stores one or more programs configured to be executed by one or more processors of a computer system. The one or more programs include instructions for: detecting that a set of one or more proximity conditions is satisfied, wherein the set of one or more proximity conditions includes a distance condition that is satisfied when a distance between a computer system and an area is determined to satisfy a threshold distance; in response to detecting that the set of one or more proximity conditions is satisfied, displaying a prompt to open an area control application that is configured to perform one or more functions associated with the area; while displaying the prompt to open the area control application, detecting an input that includes selection of the prompt; in response to detecting the input that includes selection of the prompt, displaying a user interface of the area control application, including displaying, in the user interface of the area control application, one or more selectable elements including an area control element; detecting an input that includes selection of the area control element; and in response to detecting the input that includes selection of the area control element, requesting that the area perform an operation corresponding to the area control element.

In accordance with some embodiments, a transitory computer-readable storage medium is described. The transitory computer-readable storage medium stores one or more programs configured to be executed by one or more processors of a computer system. The one or more programs include instructions for: detecting that a set of one or more proximity conditions is satisfied, wherein the set of one or more proximity conditions includes a distance condition that is satisfied when a distance between a computer system and an area is determined to satisfy a threshold distance; in response to detecting that the set of one or more proximity conditions is satisfied, displaying a prompt to open an area control application that is configured to perform one or more functions associated with the area; while displaying the prompt to open the area control application, detecting an input that includes selection of the prompt; in response to detecting the input that includes selection of the prompt, displaying a user interface of the area control application, including displaying, in the user interface of the area control application, one or more selectable elements including an area control element; detecting an input that includes selection of the area control element; and in response to detecting the input that includes selection of the area control element, requesting that the area perform an operation corresponding to the area control element.

In accordance with some embodiments, a computer system is described. The computer system comprises one or more processors and memory storing one or more programs configured to be executed by the one or more processors. The one or more programs include instructions for: detecting that a set of one or more proximity conditions is satisfied, wherein the set of one or more proximity conditions includes a distance condition that is satisfied when a distance between a computer system and an area is determined to satisfy a threshold distance; in response to detecting that the set of one or more proximity conditions is satisfied, displaying a prompt to open an area control application that is configured to perform one or more functions associated with the area; while displaying the prompt to open the area control application, detecting an input that includes selection of the prompt; in response to detecting the input that includes selection of the prompt, displaying a user interface of the area control application, including displaying, in the user interface of the area control application, one or more selectable elements including an area control element; detecting an input that includes selection of the area control element; and in response to detecting the input that includes selection of the area control element, requesting that the area perform an operation corresponding to the area control element.

In accordance with some embodiments, a computer system is described. The computer system comprises: means for detecting that a set of one or more proximity conditions is satisfied, wherein the set of one or more proximity conditions includes a distance condition that is satisfied when a distance between a computer system and an area is determined to satisfy a threshold distance; means for, in response to detecting that the set of one or more proximity conditions is satisfied, displaying a prompt to open an area control application that is configured to perform one or more functions associated with the area; means for, while displaying the prompt to open the area control application, detecting an input that includes selection of the prompt; means for, in response to detecting the input that includes selection of the prompt, displaying a user interface of the area control application, including displaying, in the user interface of the area control application, one or more selectable elements including an area control element; means for detecting an input that includes selection of the area control element; and means for, in response to detecting the input that includes selection of the area control element, requesting that the area perform an operation corresponding to the area control element.

In accordance with some embodiments, a computer program product is described. The computer program product comprises one or more programs configured to be executed by one or more processors of a computer system. The one or more programs include instructions for: detecting that a set of one or more proximity conditions is satisfied, wherein the set of one or more proximity conditions includes a distance condition that is satisfied when a distance between a computer system and an area is determined to satisfy a threshold distance; in response to detecting that the set of one or more proximity conditions is satisfied, displaying a prompt to open an area control application that is configured to perform one or more functions associated with the area; while displaying the prompt to open the area control application, detecting an input that includes selection of the prompt; in response to detecting the input that includes selection of the prompt, displaying a user interface of the area control application, including displaying, in the user interface of the area control application, one or more selectable elements including an area control element; detecting an input that includes selection of the area control element; and in response to detecting the input that includes selection of the area control element, requesting that the area perform an operation corresponding to the area control element.

In accordance with some embodiments, a method is described. The method comprises: displaying, at a computer system, a set of one or more environmental control elements; detecting an input that includes selection of a first environmental control element of the set of one or more environmental control elements; and in response to detecting the input that includes selection of the first environmental control element, setting a respective environmental parameter for a respective location of an area, including: in accordance with a determination that the computer system is located at a first location relative to the area, setting the respective environmental parameter for the first location; and in accordance with a determination that the computer system is located at a second location, different from the first location, relative to the area, setting the respective environmental parameter for the second location.

In accordance with some embodiments, a non-transitory computer-readable storage medium is described. The non-transitory computer-readable storage medium stores one or more programs configured to be executed by one or more processors of a computer system. The one or more programs include instructions for: displaying, at a computer system, a set of one or more environmental control elements; detecting an input that includes selection of a first environmental control element of the set of one or more environmental control elements; and in response to detecting the input that includes selection of the first environmental control element, setting a respective environmental parameter for a respective location of an area, including: in accordance with a determination that the computer system is located at a first location relative to the area, setting the respective environmental parameter for the first location; and in accordance with a determination that the computer system is located at a second location, different from the first location, relative to the area, setting the respective environmental parameter for the second location.

In accordance with some embodiments, a transitory computer-readable storage medium is described. The transitory computer-readable storage medium stores one or more programs configured to be executed by one or more processors of a computer system. The one or more programs include instructions for: displaying, at a computer system, a set of one or more environmental control elements; detecting an input that includes selection of a first environmental control element of the set of one or more environmental control elements; and in response to detecting the input that includes selection of the first environmental control element, setting a respective environmental parameter for a respective location of an area, including: in accordance with a determination that the computer system is located at a first location relative to the area, setting the respective environmental parameter for the first location; and in accordance with a determination that the computer system is located at a second location, different from the first location, relative to the area, setting the respective environmental parameter for the second location.

In accordance with some embodiments, a computer system is described. The computer system comprises one or more processors and memory storing one or more programs configured to be executed by the one or more processors. The one or more programs include instructions for: displaying, at a computer system, a set of one or more environmental control elements; detecting an input that includes selection of a first environmental control element of the set of one or more environmental control elements; and in response to detecting the input that includes selection of the first environmental control element, setting a respective environmental parameter for a respective location of an area, including: in accordance with a determination that the computer system is located at a first location relative to the area, setting the respective environmental parameter for the first location; and in accordance with a determination that the computer system is located at a second location, different from the first location, relative to the area, setting the respective environmental parameter for the second location.

In accordance with some embodiments, a computer system is described. The computer system comprises: means for displaying, at a computer system, a set of one or more environmental control elements; means for detecting an input that includes selection of a first environmental control element of the set of one or more environmental control elements; and means for, in response to detecting the input that includes selection of the first environmental control element, setting a respective environmental parameter for a respective location of an area, including: in accordance with a determination that the computer system is located at a first location relative to the area, setting the respective environmental parameter for the first location; and in accordance with a determination that the computer system is located at a second location, different from the first location, relative to the area, setting the respective environmental parameter for the second location.

In accordance with some embodiments, a computer program product is described. The computer program product comprises one or more programs configured to be executed by one or more processors of a computer system. The one or more programs include instructions for: displaying, at a computer system, a set of one or more environmental control elements; detecting an input that includes selection of a first environmental control element of the set of one or more environmental control elements; and in response to detecting the input that includes selection of the first environmental control element, setting a respective environmental parameter for a respective location of an area, including: in accordance with a determination that the computer system is located at a first location relative to the area, setting the respective environmental parameter for the first location; and in accordance with a determination that the computer system is located at a second location, different from the first location, relative to the area, setting the respective environmental parameter for the second location.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for controlling an area, thereby increasing the effectiveness, efficiency, and user satisfaction with such devices. Such methods and interfaces may complement or replace other methods for controlling an area.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2I illustrate example techniques for controlling an area, in accordance with some embodiments.

FIG. 3 is a flow diagram illustrating methods for controlling an area, in accordance with some embodiments.

FIGS. 4A-4K illustrate example techniques for controlling environmental parameters of an area, in accordance with some embodiments.

FIG. 5 is a flow diagram illustrating methods for controlling environmental parameters of an area, in accordance with some embodiments.

### DETAILED DESCRIPTION

The following description sets forth exemplary techniques for controlling an area. This description is not intended to limit the scope of this disclosure but is instead provided as a description of example implementations.

Users need electronic devices that provide effective techniques for controlling an area. Efficient techniques can reduce a user's mental load when controlling an area. This reduction in mental load can enhance user productivity and make the device easier to use. In some embodiments, the techniques described herein can reduce battery usage and processing time (e.g., by providing user interfaces that require fewer user inputs to operate).

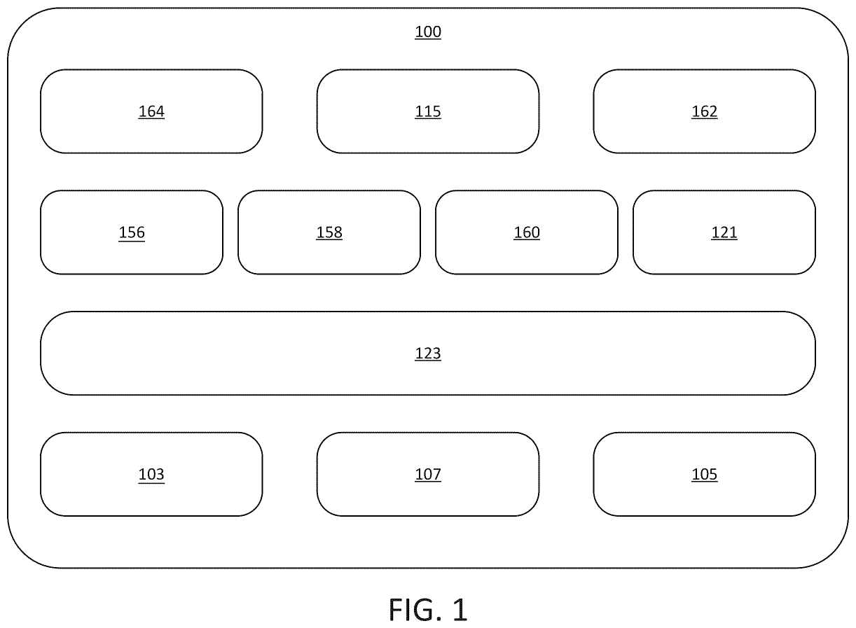

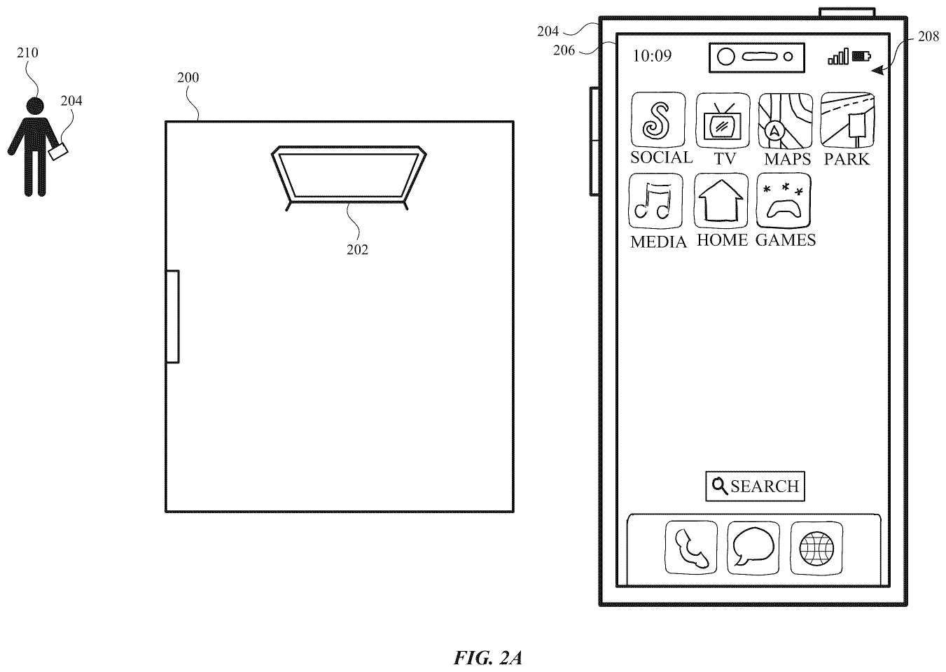

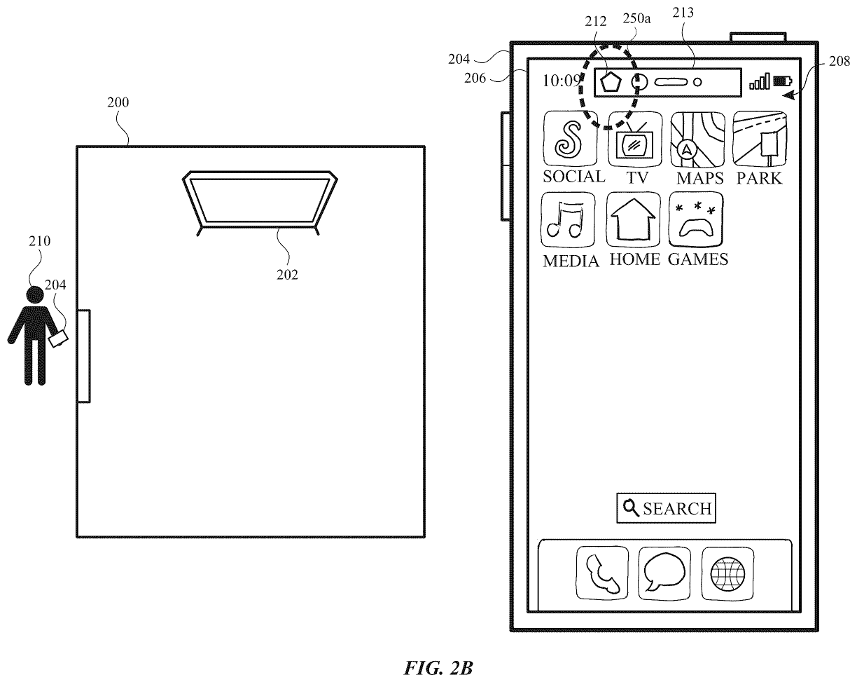

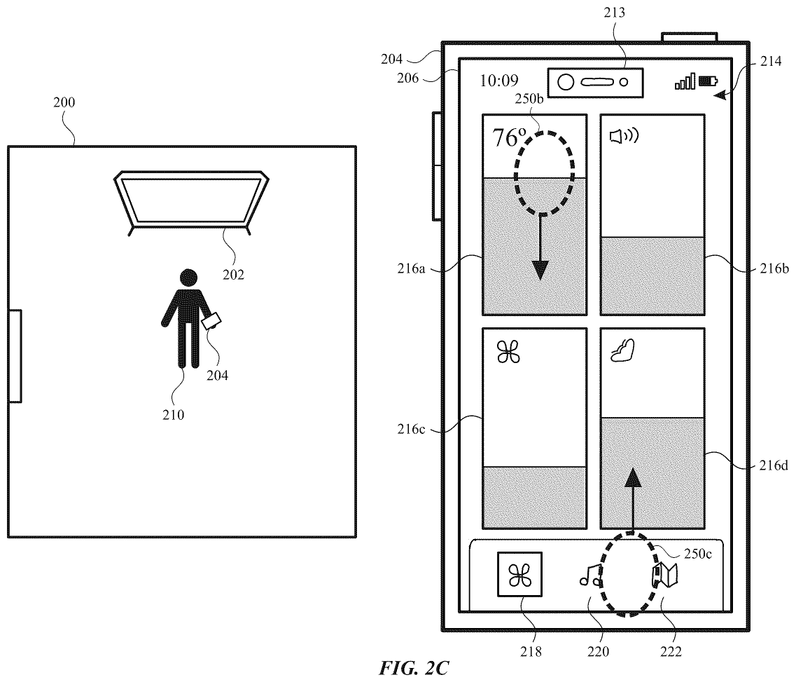

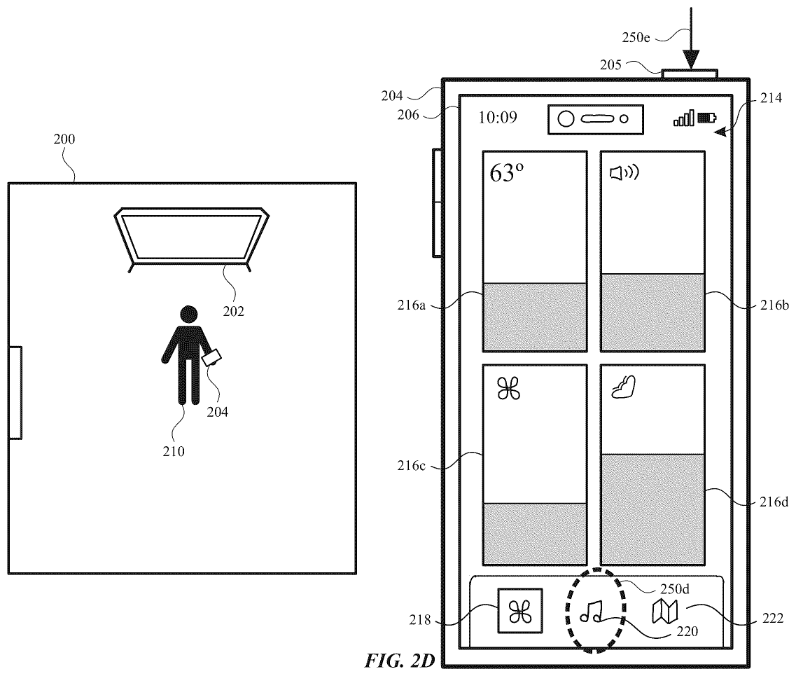

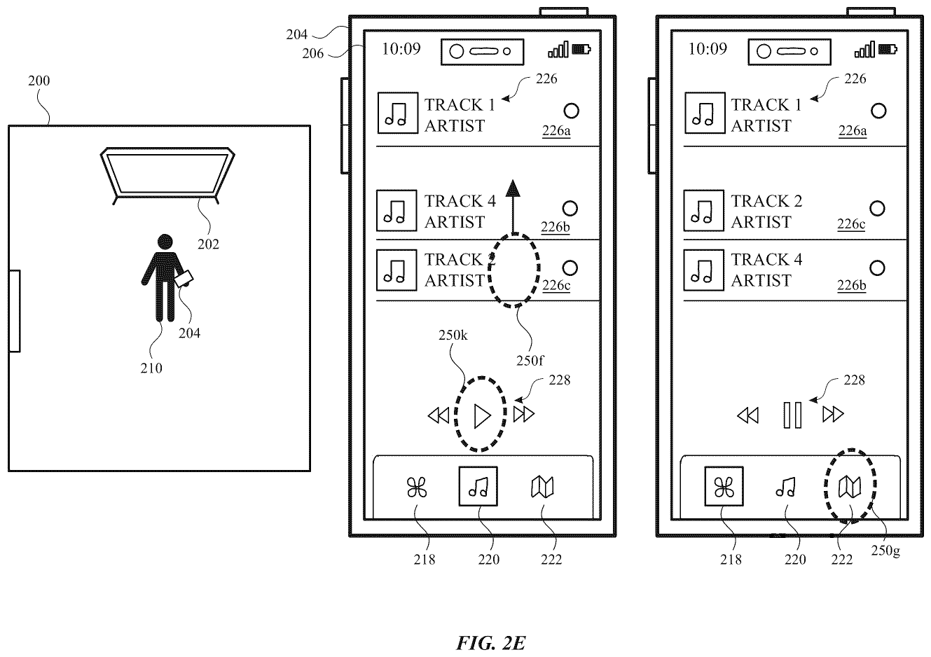

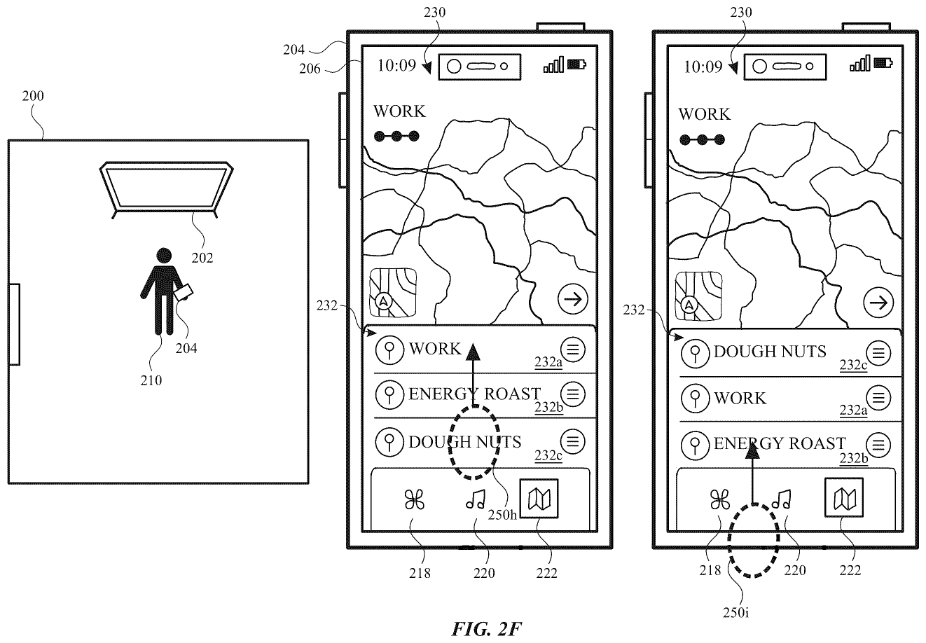

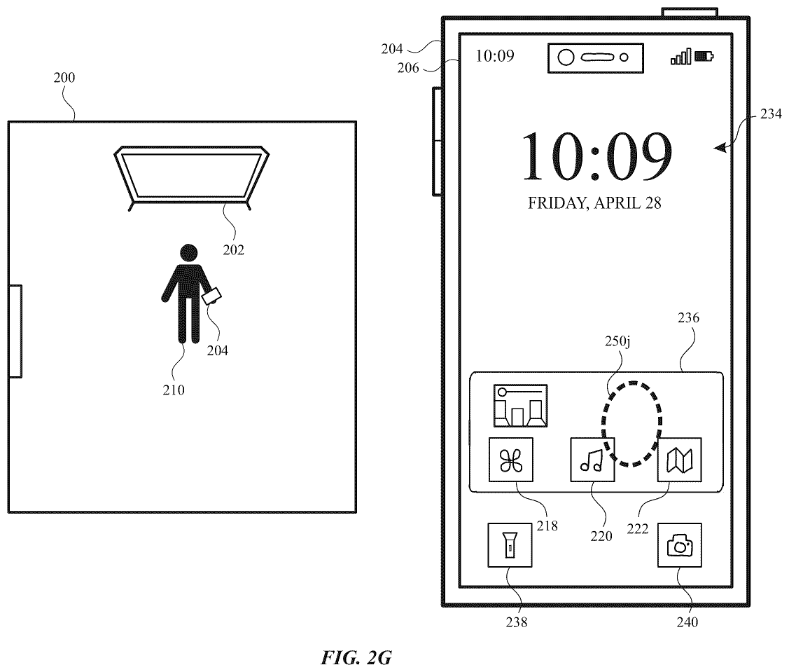

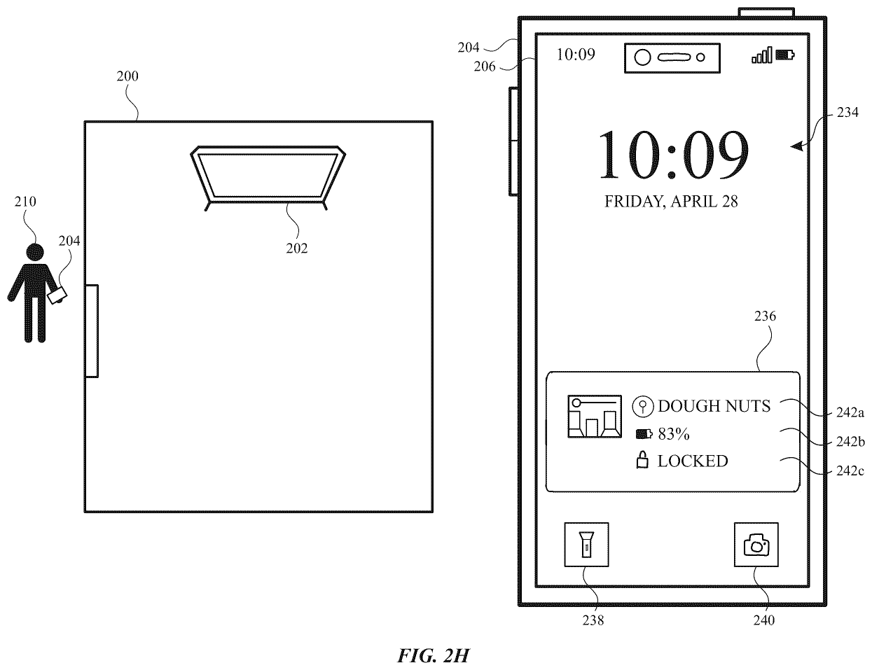

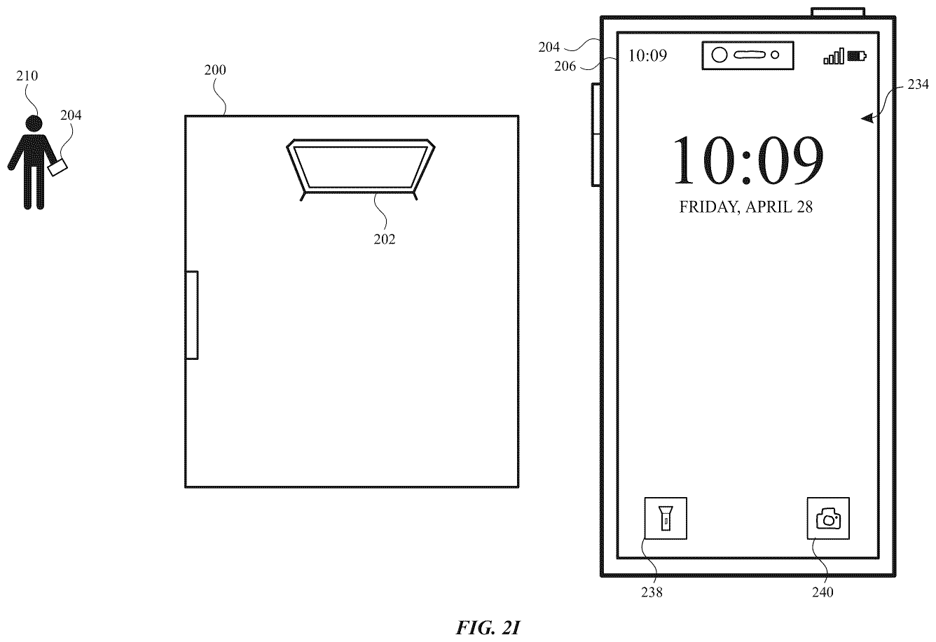

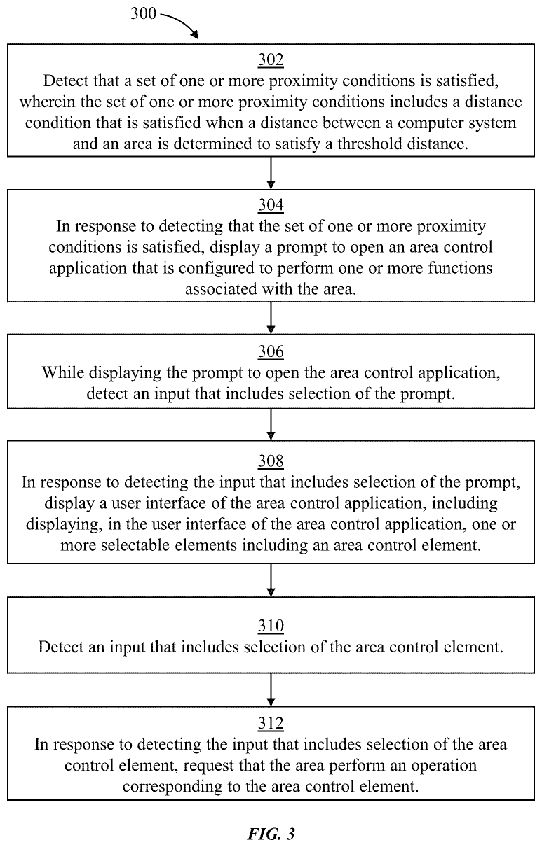

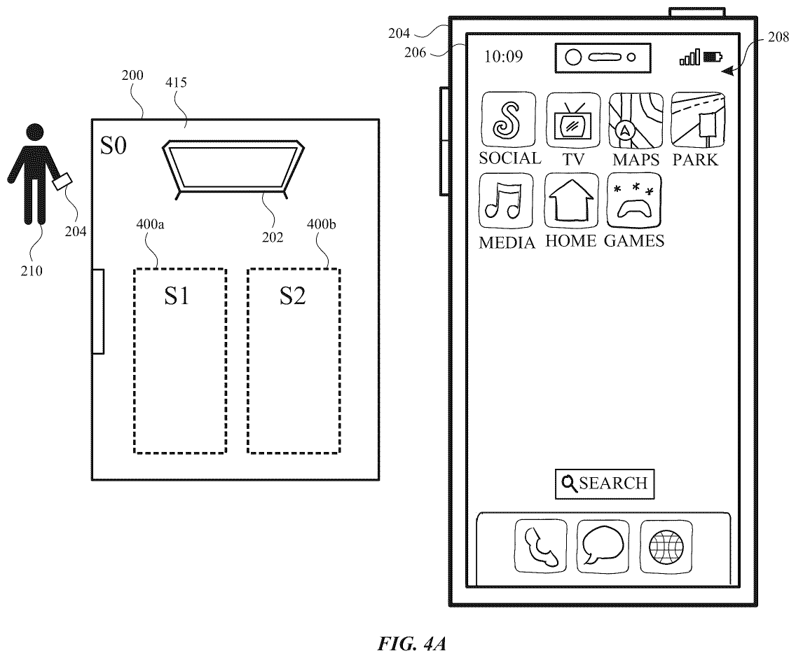

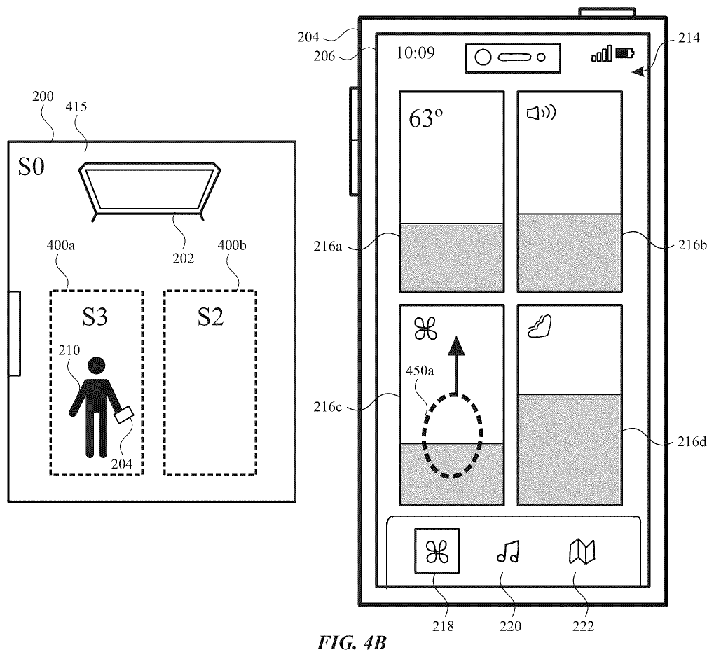

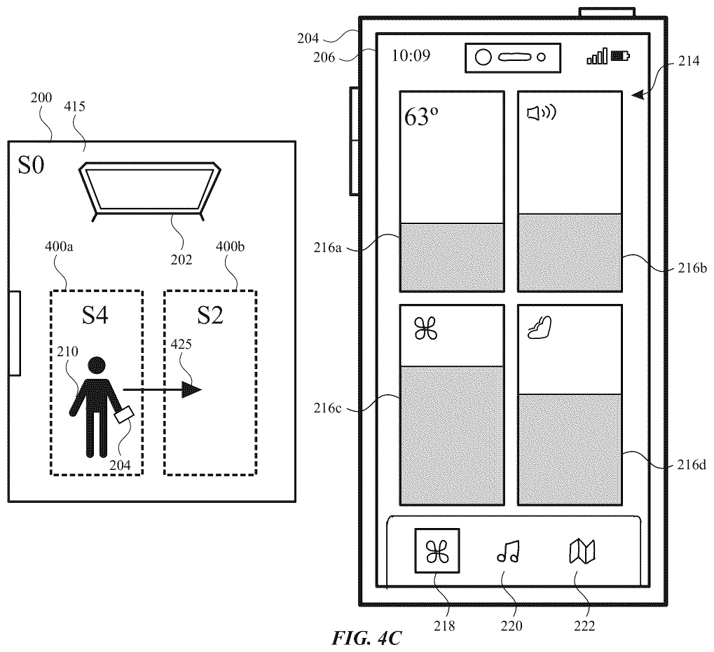

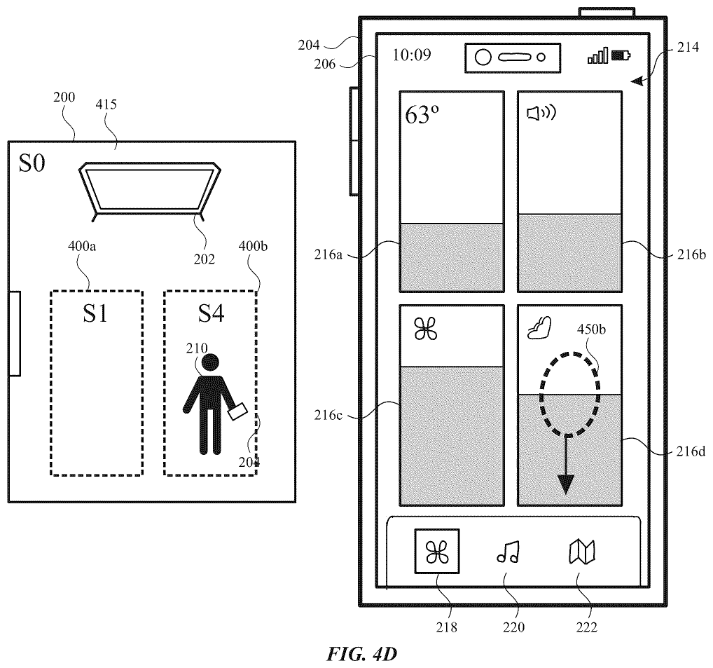

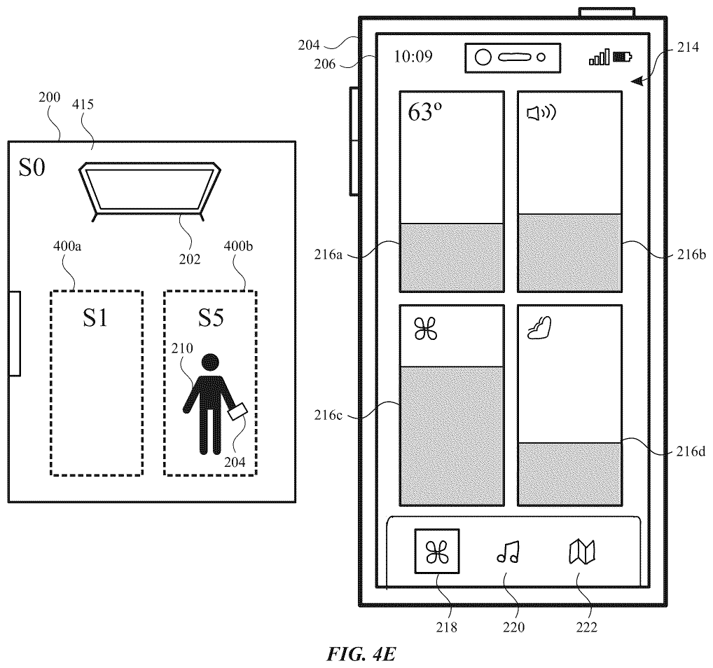

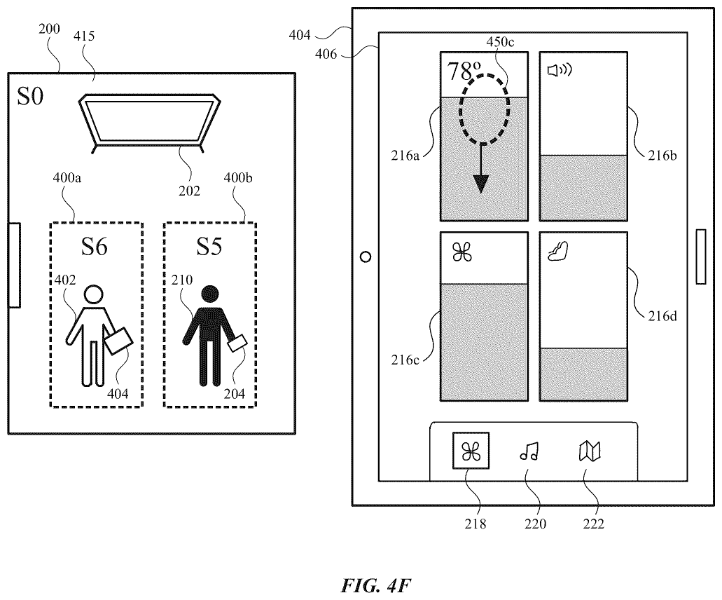

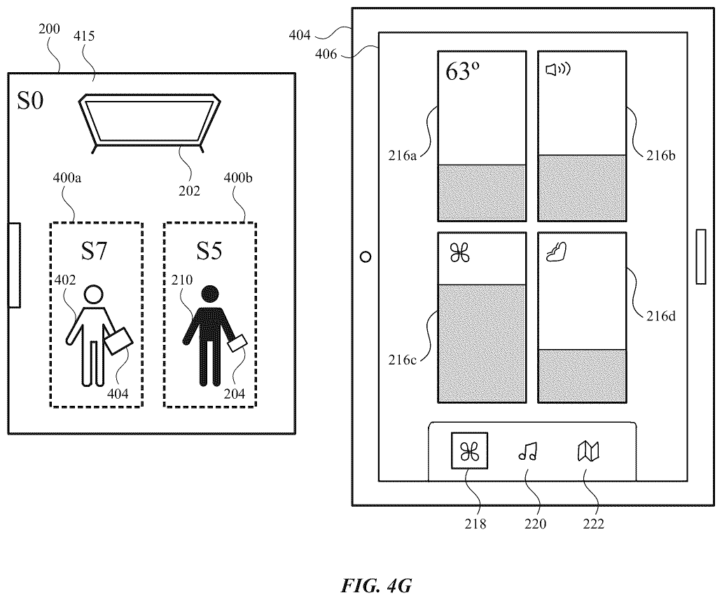

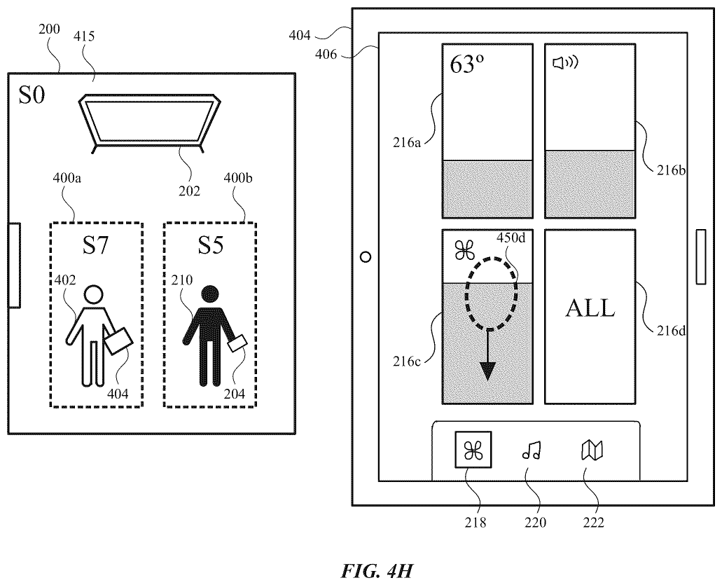

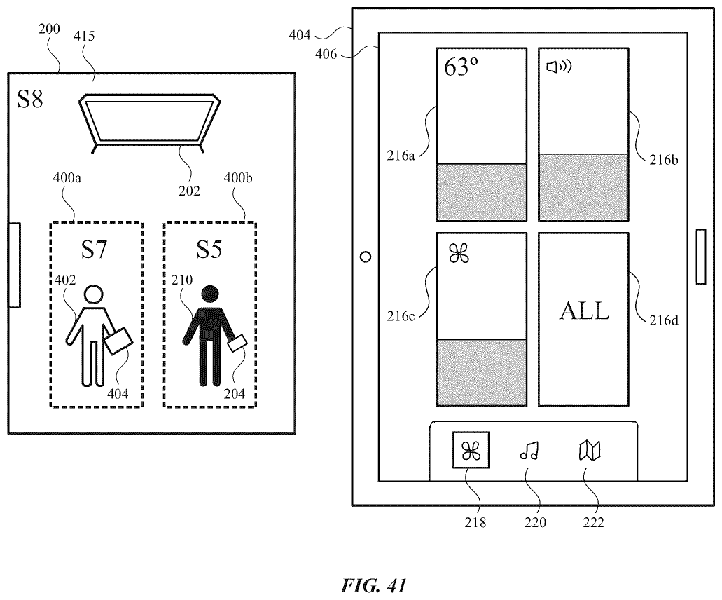

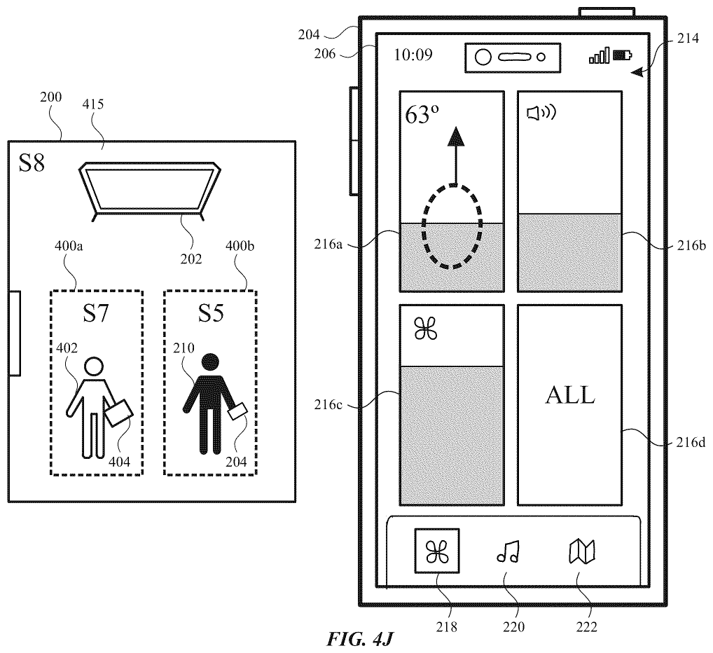

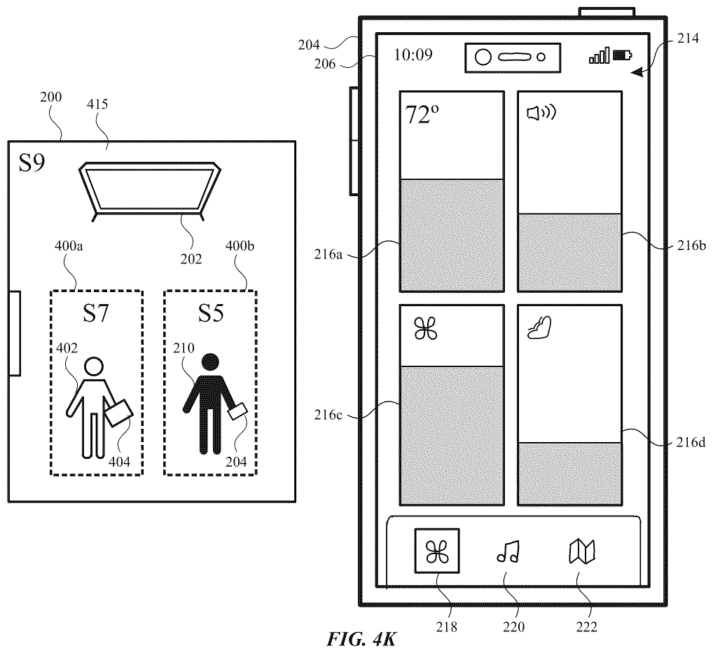

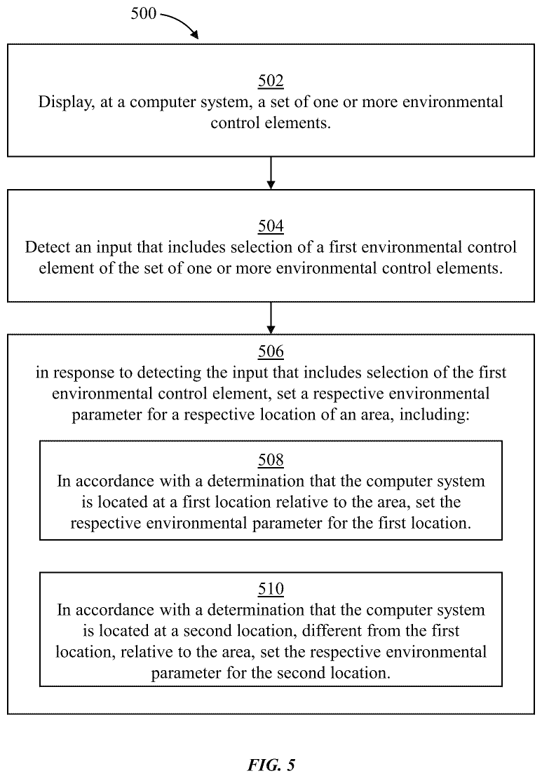

FIG. 1 provides illustrations of exemplary devices for performing techniques for controlling an area. FIGS. 2A-2I illustrate exemplary user interfaces for controlling an area in accordance with some embodiments. FIG. 3 is a flow diagram illustrating methods of controlling an area in accordance with some embodiments. The user interfaces in FIGS. 2A-2I are used to illustrate the processes described below, including the processes in FIG. 3. FIGS. 4A-4K illustrate exemplary user interfaces for controlling environmental parameters of an area in accordance with some embodiments. FIG. 5 is a flow diagram illustrating methods of controlling environmental parameters of an area in accordance with some embodiments. The user interfaces in FIGS. 4A-4K are used to illustrate the processes described below, including the processes in FIG. 5.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human car, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3 and/or 5 (e.g., methods 300 and/or 500) and/or portions of these methods.

In FIG. 1, system 100 includes various components, such as processor(s) 103, RF circuitry (ies) 105, memory (ies) 107, sensors 156 (e.g., image sensor(s), orientation sensor(s), location sensor(s), heart rate monitor(s), temperature sensor(s)), input component(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output component(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input component.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory (ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry (ies) 105 includes circuitry for communicating with electronic devices and/or networks (e.g., the Internet, intranets, and/or a wireless network, such as cellular networks and wireless local area networks (LANs)). In some embodiments, RF circuitry (ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of an area. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of an area and/or a platform. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input component(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input component(s) 158 include one or more input devices inside system 100. In some embodiments, input component(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the area. In some embodiments, mobility system 164 includes powertrain(s), drivetrain(s), motor(s) (e.g., an electrical motor), engine(s), power source(s) (e.g., battery (ies)), transmission(s), suspension system(s), speed control system(s), and/or steering system(s). In some embodiments, one or more elements of mobility component(s) are configured to be controlled autonomously or manually (e.g., via system 100 and/or input component(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105.

In some embodiments, system 100 is capable of communicating with other computer systems and/or electronic devices. For example, system 100 can use RF circuitry (ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry (ies) 105. In some embodiments, system 100 receives, using the RF circuitry (ies) 105, video and/or audio from the other system(s) in the videoconferencing communication sessions, and presents the video and/or audio using output component(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output component(s) 160. In some embodiments, output component(s) 160 generates the tactile outputs by displacing a moveable mass relative to a neutral position. In some embodiments, tactile outputs are periodic in nature, optionally including frequency (ies) and/or amplitude(s) of movement in two or three dimensions. In some embodiments, system 100 generates a variety of different tactile outputs differing in frequency (ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency (ies) corresponds to faster movement(s) by the moveable mass whereas lower frequency (ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input component(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input component(s) 158 to detect the user speaking one or more words. In some embodiments, system 100 parses and/or communicates information to one or more other systems to determine contents of the speech of the user, including identifying words and/or obtaining a semantic understanding of the words. For example, system processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output component(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry (ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as the area 100 functioning as a key to initiate operation of an actuation system of an area and/or a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry (ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

FIGS. 2A-2I illustrate example techniques for controlling an area, in accordance with some embodiments. FIG. 3 is a flow diagram of an exemplary method 300 for controlling an area, in accordance with some embodiments. The example embodiments shown in FIGS. 2A-2I are used to illustrate the processes described below, including the processes in FIG. 3.

FIG. 2A shows area 200, user 210, and computer system 204 associated with user 210. Area 200 includes display 202. In some embodiments, display 202 is controlled by a computer system included in and/or in communication with area 200. In FIG. 2A, user 210 is outside area 200 and computer system 204 displays user interface 208 (e.g., a home screen) on display 206 (e.g., a touch-sensitive display).

In FIG. 2B, user 210 approaches area 200. In response to detecting that a set of one or more proximity conditions is satisfied, including that a distance between computer system 204 and area 200 is less than a threshold distance, computer system 204 displays prompt 212. In the embodiment illustrated in FIG. 2B, computer system 204 expands region 213 of user interface 208 (e.g., compared to the configuration of region 213 in FIG. 2A) and displays prompt 212 in region 213.

In FIG. 2B, computer system 204 detects input 250a (e.g., a tap and/or other input) selecting prompt 212. In response to detecting input 250a, computer system 204 opens an application (referred to herein as the area control application) for controlling and/or displaying information associated with area 200, as shown in FIG. 2C. In the embodiment shown in FIG. 2C, computer system 204 displays environment control user interface 214 (e.g., corresponding to environment control tab 218), which includes environment temperature control element 216a for controlling a temperature setting of area 200, volume control element 216b for controlling a volume setting of area 200, fan speed control element 216c for controlling a speed of a fan of area 200, and seat temperature control element 216d for controlling a temperature of a seat within area 200 (collectively referred to as area control elements 216). In some embodiments, the appearance of area control elements 216 indicate a current setting and/or state of the respective setting.

In response to detecting input 250c (e.g., a swipe gesture and/or other input) corresponding to a request to navigate away from user interface 214, computer system 204 displays (e.g., returns to) user interface 208 as shown in FIG. 2B. In some embodiments, in some embodiments, in response to detecting input 250c, computer system 204 displays user interface 234 described with reference to FIGS. 2G-2I. In response to detecting input 250b (e.g., a drag gesture, swipe gesture, and/or other input) directed to environment temperature control element 216a corresponding to a request to decrease the temperature in area 200, computer system 204 decreases the environmental temperature setting of area 200, as indicated by the appearance of environment temperature control element 216a in FIG. 2D.

In some embodiments, in response to detecting input 250e (e.g., a press and/or activation of button 205) in FIG. 2D, computer system 204 displays user interface 234 described with reference to FIGS. 2G-2I. In response to detecting input 250d (e.g., a tap and/or other input) selecting media control tab 220 in FIG. 2D, computer system 204 displays media control user interface 224 as shown in the middle of FIG. 2E. Media control user interface 224 includes media queue 226 of media items (e.g., songs and/or tracks) for playback in area 200, including media item 226a (e.g., the current track), media item 226b (e.g., the next track to be played after the current track), and media item 226c (e.g., the last track in media queue 226). In response to detecting input 250f (e.g., a drag gesture, swipe gesture, and/or other input) corresponding to a request to edit media queue 226, computer system 204 edits media queue 226 by moving media item 226c up to the next track to be played and moving media item 226b to the bottom or end of media queue 226, as shown in the right side of FIG. 2E. In response to detecting input 250f (e.g., a tap and/or other input) selecting playback control element 228 (e.g., play button), computer system 204 initiates playback of the media item at the top or beginning of media queue 226 (e.g., “Track 1”) in area 200, as indicated in the right side of FIG. 2E by changing the appearance of playback control element 228 (e.g., from a play symbol to a pause symbol).

In FIG. 2E, computer system 204 detects input 250g (e.g., a tap and/or other input) selecting navigation tab 222. In response to detecting input 250g, computer system 204 displays navigation user interface 230, which includes destination queue 232 of planned destinations for area 200, as shown in the middle of FIG. 2F. Destination queue 232 includes first destination 232a (e.g., the current destination for area 200), second destination 232b (e.g., an intermediate destination for area 200), and third destination 232c (e.g., a final destination for area 200). In response to detecting input 250h (e.g., a drag gesture, swipe gesture, and/or other input) corresponding to a request to edit destination queue 232, computer system 204 edits destination queue 232 for area 200 by moving third destination 232c to the top of destination queue 232, as shown in the right side of FIG. 2F.

In FIG. 2F, computer system 204 detects input 250i (e.g., a drag gesture, swipe gesture, and/or other input) corresponding to a request to navigate away from the user interface for the area control application. In some embodiments, in response to detecting input 250i, computer system 204 displays user interface 208 as shown in FIG. 2B (e.g., with prompt 212 corresponding to the area control application in region 213). In some embodiments, when computer system 204 navigates away from the area control application, computer system 204 runs the area control application as a background process. In some embodiments, computer system 204 initiates the area control application and runs the area control application as a background process in response to detecting that the set of one or more proximity conditions is satisfied (e.g., in FIG. 2B).

Turning to FIG. 2G, computer system 204 displays user interface 234. In some embodiments, user interface 234 is a wake screen that is displayed when computer system 204 is in a reduced power state or when computer system 204 transitions from a reduced power state. In some embodiments, user interface 234 is a lock screen that is displayed when computer system 204 is in a state in which only a predetermined set of functions are available. For example, in some embodiments, while computer system 204 is locked, a flashlight functionality can be activated by selecting flashlight icon 238 and a camera application can be activated by selecting camera icon 240. Because user 210 is in area 200, computer system 204 displays area control element 236 while displaying user interface 234. Area control element 236 includes environment control tab 218, media control tab 220, and navigation tab 222 for accessing information and/or selectable options for controlling area 200. In some embodiments, a user can customize the control elements displayed in area control element 236 (e.g., via a settings menu on computer system 204). In some embodiments, if user 210 is not in area 200, but is within a threshold distance of area 200, then computer system 204 displays different content and/or controls in area control element 236. For example, in FIG. 2H, because user 210 is not inside area 200, but is within a threshold distance of area 200, computer system 204 displays area control element 236 with destination indicator 242a, battery level indicator 242b (e.g., an indication of a battery and/or charge level of area 200), and lock status indicator 242c (e.g., an indication of the locked status of area 200). In some embodiments, if user 210 is not within the threshold distance of area 200, then computer system 204 displays user interface 234 without area control element 236, as shown in FIG. 2I.

Additional descriptions regarding FIGS. 2A-2I are provided below in reference to method 300 described with respect to FIG. 3.

FIG. 3 is a flow diagram of an exemplary method 300 for controlling an area, in accordance with some embodiments. In some embodiments method 300 is performed at a computer system (e.g., computer system 152 and/or 204) and/or an area (e.g., area 200, a platform, a vehicle, an interior of a vehicle, a cabin of a vehicle, and/or a portion thereof). In some embodiments, method 300 is governed by instructions that are stored in a non-transitory (or transitory) computer-readable storage medium and that are executed by one or more processors of a computer system (e.g., 152 and/or 204), such as the one or more processors 103 of system 100. Some operations in method 300 are, optionally, combined and/or the order of some operations is, optionally, changed.

In some embodiments, a computer system (e.g., 152, 202, 204, and/or 404) (e.g., a smartphone, a smartwatch, a tablet computer, and/or a head-mounted display device) detects (302) (e.g., via GPS and/or one or more sensors, such as an ultra-wide band sensor and/or a near-field communication sensor) that a set of one or more proximity conditions is satisfied, wherein the set of one or more proximity conditions includes a distance condition that is satisfied when a distance (e.g., a physical distance, a measurable distance, a measured distance, and/or an estimated distance) between the computer system and an area (e.g., 200, a vehicle, car, truck, automobile, van, and/or bus) is determined to satisfy (e.g., is less than, is equal to, or is less than or equal to) a threshold distance (e.g., 0 feet, 5 feet, 10 feet, 25 feet, 50 feet, or 100 feet). In response to detecting that the set of one or more proximity conditions is satisfied, the computer system displays (304) (e.g., via display(s) 121, display 206, a display component, a display, a display device, a touch-screen display, and/or a monitor) a prompt (e.g., 212) (e.g., a user interface element, a user-interactive user interface element, a button, a selectable icon, and/or an affordance) to open (e.g., launch, execute, and/or display a user interface of) an area control application that is configured to perform one or more functions associated with the area. While displaying the prompt to open the area control application, the computer system detects (306) (e.g., via one or more input devices such as 206, touch-sensitive surface(s) 115, input device(s) 158, a mouse, and/or a button) an input (e.g., 250a) (e.g., a touch gesture on a touch-sensitive surface, an air gesture, a voice command, a button press, and/or other selection input) that includes selection of the prompt. In response to detecting the input that includes selection of the prompt, the computer system displays (308) a user interface (e.g., 214, 224, or 230) of the area control application, including displaying, in the user interface of the area control application, one or more selectable elements (e.g., 216, 226, 228, and/or 232) including an area control element (e.g., 216a, 216b, 216c, or 216d, 226a, 226b, 226c, 228, 232a, 232b, or 232c). The computer system detects (310) an input (e.g., 250b, 250f, and/or 250h) (e.g., a touch gesture on a touch-sensitive surface, an air gesture, a voice command, a button press, and/or other selection input) that includes selection of the area control element. In response to detecting the input that includes selection of the area control element, the computer system requests (312) that the area perform an operation corresponding to the area control element (e.g., the computer system initiates, transmits, and/or sends (e.g., via wireless communication) instructions to the area to perform the operation corresponding to the area control element) (e.g., change an environmental parameter as in FIGS. 2C-2D; control media playback as in FIG. 2E; edit a queue of media items as in FIG. 2E, and/or edit a destination queue as in FIG. 2F).

In some embodiments, in accordance with (or, in some embodiments, in response to) a determination that the computer system is within the area (e.g., has entered the area and/or is inside an interior of the area, such as a cabin) (e.g., as shown in FIGS. 2C-2G), the computer system executes (e.g., runs) the area control application as a background process on the computer system (e.g., without displaying the user interface of the area control application). In some embodiments, the computer system executes the area control application as a background process prior to selection of the prompt and/or after closing and/or navigating away from the user interface of the area control application.

In some embodiments, displaying the prompt includes: in accordance with a determination that the computer system is inside the area, displaying the prompt in a dynamic area (e.g., 213) of a display (e.g., 206) of the computer system. In some embodiments, the dynamic area includes a contracted state that covers a first area and an expanded state that occupies a second area, and the prompt is displayed in a portion of the second area that is not included in the first area. In some embodiments, displaying the prompt includes expanding the dynamic area (e.g., changing the dynamic area from the contracted state to the expanded state) and displaying the prompt in the dynamic area while the dynamic area is expanded. In some embodiments, the prompt is displayed in the dynamic area while the computer system is displaying a home screen, a lock screen, a wake screen, an application springboard, and/or a user interface other than the user interface of the area control application (e.g., a user interface of a different application). In some embodiments, a home screen and/or an application springboard includes a plurality of selectable application icons corresponding to respective applications that, when the application icons are selected, cause the computer system to open the application corresponding to the selected application icon. In some embodiments, a wake screen is a user interface that is displayed when the computer system is in a low-power state and/or a resting state and/or when the computer system transitions from a low-power state and/or resting state to a normal operating state.

In some embodiments, the computer system ceases display of the user interface of the area control application; while the user interface of the area control application is not displayed (e.g., while the computer system is displaying a home screen, a lock screen, a wake screen, an application springboard, and/or a user interface other than the user interface of the area control application, the computer system displays an interactive area control user interface element (e.g., 236) that includes one or more selectable control elements (e.g., 218, 220, and/or 222); the computer system detects a user input (e.g., 250k) that includes selection of a first control element of the one or more selectable control elements; and in response to detecting selection of the first control element, the computer system requests (e.g., transmits and/or sends (e.g., via wireless communication) instructions to) the area to perform an operation corresponding to the first control element. In some embodiments, the interactive area control user interface element is displayed while the computer system is in a locked state (e.g., a user interface locked state) in which functionality of the computer system is limited to a predetermined set of functions.

In some embodiments, displaying the interactive area control user interface element includes displaying the interactive area control user interface element having content that is based on a context (e.g., a state of the computer system and/or a location of the computer system). In some embodiments, displaying the interactive area control user interface element includes: in accordance with a determination that the computer system (or, in some embodiments, a user associated with the computer system) is inside the area (e.g., as shown in FIG. 2G), displaying the interactive area control user interface element having a first set of one or more selectable control elements (e.g., selectable control elements that, when selected, cause the computer system to control playback of media (e.g., a song and/or video) being played in the area and/or to control an environment setting of the area (e.g., temperature and/or fan speed)) (e.g., 236 as shown in FIG. 2G). In some embodiments, displaying the interactive area control user interface element includes: in accordance with a determination that the computer system (or, in some embodiments, a user associated with the computer system) is not inside the area (e.g., is outside the area) (e.g., as shown in FIG. 2H), displaying the interactive area control user interface element having a second set of one or more selectable control elements (e.g., that are different from the first set of one or more selectable control elements) (e.g., including a selectable control element that, when selected, causes the computer system to lock or unlock the area) (e.g., 236 as shown in FIG. 2H).

In some embodiments, the set of one or more proximity conditions does not require the computer system to have an account associated with the area (e.g., the computer system can control the area without having an account associated with the area). In some embodiments, the set of one or more proximity conditions does not require the computer system to have previously performed a configuration associated with the area (e.g., the computer system does not have to have previously set up access to the area and/or set up an account associated with the area) (e.g., the computer system can control the area without prior setup).

In some embodiments, the operation corresponding to the area control element includes controlling (e.g., setting, changing, selecting, and/or adjusting) an environment (e.g., climate) control parameter (e.g., a fan speed, a temperature, an air conditioning state, a heater state, and/or a vent setting) of the area (e.g., as described with reference to FIGS. 2C-2D). In some embodiments, the operation corresponding to the area control element includes controlling (e.g., setting, changing, selecting, and/or adjusting) a media parameter for the area (e.g., a media source, a media channel, a media item for playback, a playback setting (such as play, stop, pause, and/or skip), and/or a media queue) (e.g., as described with reference to FIG. 2E). In some embodiments, the operation corresponding to the area control element includes controlling (e.g., setting, changing, selecting, and/or adjusting) a destination parameter for the area (e.g., a destination for the area, an initial destination, a current destination, a final destination, an intermediate destination, and/or a queue of destinations) (e.g., as described with reference to FIG. 2F). In some embodiments, the operation corresponding to the area control element includes editing a queue (e.g., a queue of media items and/or a queue of locations, such as destinations) associated with the area (e.g., adding an item to the queue, removing an item from the queue, and/or rearranging the items currently in the queue) (e.g., as described with media queue 226 in FIG. 2E and/or destination queue 232 in FIG. 2F). In some embodiments, the computer system detects an input that includes selection of a user interface setting (e.g., a configuration, appearance, and/or one or more elements) for the user interface of the area (e.g., selection of applications, graphical elements, and/or selectable elements to be included in the one or more selectable elements), wherein displaying the user interface (e.g., 214, 224, and/or 230) of the area control application includes displaying the user interface of the area control application according to the user interface setting (e.g., a user can customize a menu of applications and/or controls on the user interface of the area control application).

FIGS. 4A-4K illustrate user interfaces and techniques for controlling environmental parameters of an area, in accordance with some embodiments. FIG. 5 is a flow diagram of an exemplary method 500 for controlling environmental parameters of an area, in accordance with some embodiments. The example embodiments shown in FIGS. 4A-4K are used to illustrate the processes described below, including the processes in FIG. 5.

FIG. 4A shows user 210 with computer system 204 outside area 200. User 210, computer system 204, and area 200 are described above with reference to FIGS. 2A-2I. FIG. 4A indicates two designated locations (e.g., areas, regions, and/or seats) within area 200, location 400a and location 400b. In FIG. 4A, a common area 415 of an interior portion of area 200 has environmental state S0. In some embodiments, an environmental state includes a temperature, fan speed, humidity, pressure, volume, and/or heater setting. Location 400a has environmental state S1 and location 400b has environmental state S2.

In FIG. 4B, user 210 enters area 200 and occupies location 400a in area 200. In response to user 210 entering area 200 and occupying location 400a, area 200 sets location 400a to environmental state S3 (e.g., changes location 400a from environmental state S1 to environmental state S3), while maintaining the environmental state of the common area of the interior portion of area 200 (e.g., at S0) and location 400b (e.g., at S2).

FIG. 4B shows an enlarged view of computer system 204 displaying user interface 214 (e.g., described above with reference to FIGS. 2C-2D). In FIG. 4B, computer system 204 detects input 450a (e.g., a drag gesture, swipe gesture, and/or other input) on fan speed control element 216c corresponding to a request to increase a fan speed. As shown in FIG. 4C, in response to detecting input 450a, the temperature in area 200 is adjusted at location 400a (e.g., as indicated by the state at location 400a changing from S3 to S4) without changing the state of common area 415 and without changing the state of location 400b (e.g., only the state of location 400a is changed).

In FIG. 4C, user 210 moves from location 400a to location 400b. As shown in FIG. 4D, in response to detecting user 210 at new location 400b, area 200 changes the state of location 400b to S4 (e.g., the state of location 400a prior to user 210 moving from location 400a to location 400b). In some embodiments, area 200 changes the state of location 400b to S4 in response to detecting user 210 at location 400b automatically without input from user 210. In this way, the state associated with user 210 can automatically move with user 210. As shown in FIG. 4D, in some embodiments, when user 210 moves from location 400a, area 200 automatically changes the state of location 400a to the state of location 400a prior to user 210 occupying location 400a (e.g., state S1 as shown in FIG. 4A).

In FIG. 4D, computer system 204 detects input 450b (e.g., a drag gesture, swipe gesture, and/or other input) corresponding to a request to change a seat temperature. In response to detecting input 450b, because user 210 occupies location 400b, the state at location 400b is changed to S5 (e.g., as a result of changing the seat temperature according to input 450b), without changing the state of common area 415 and without changing the state of location 400a, as shown in FIG. 4E.

Turning to FIG. 4F, user 402 enters area 200 and occupies location 400a. User 402 is associated with electronic device 404. When user 402 enters area 200, user 402 is associated with state S6 represented by the settings shown in user interface 214 displayed on display 406 of electronic device 404 in FIG. 4F. User interface 214 is described above with reference to computer system 204. In some embodiments, electronic device 404 of user 402 includes the same area control application used by user 210 to control settings of area 200. In response to detecting user 402 at location 400a, area 200 sets location 400a to the state associated with user 402 (e.g., state S6) without changing the state of common area 415 and without changing the state of location 400b.

In FIG. 4F, electronic device 404 of user 402 detects input 450c (e.g., a drag gesture, swipe gesture, and/or other input) corresponding to a request to adjust a temperature setting. In response to detecting input 450c, because user 402 is at location 400a, the state of location 400a is changed to S7 according to input 450c (e.g., by decreasing the temperature setting at location 400a) without changing the state of common area 415 and without changing the state of location 400b, as shown in FIG. 4G.

Turning to FIG. 4H, electronic device 404 of user 402 displays common environment control user interface 408, which includes control elements 410a-410c for controlling the state of common area 415. In response to detecting input 450d (e.g., a drag gesture, swipe gesture, and/or other input) corresponding to a request to change a fan speed, the state of common area 415 is changed to S8 without changing the state of location 400a and without changing the state of location 400b, as shown in FIG. 4I. In this way, user 402 can control the state of common area 415 without affecting other areas of area 200.

Turning to FIG. 4J, area 200, user 210, and user 402 are in the same configuration as in FIG. 4I and an enlarged view of computer system 204 of user 210 is shown. Computer system 204 displays user interface 408, described above with reference to electronic device 404 of user 4022, for controlling the state of common area 415. In FIG. 4J, computer system 204 detects input 450e (e.g., a drag gesture, swipe gesture, and/or other input) corresponding to a request to adjust a temperature setting. In response to detecting input 450e, the state of common area 415 is changed to S9 without changing the state of location 400a and without changing the state of location 400b, as shown in FIG. 4K. In this way, user 210 can control the state of common area 415 without affecting other areas of area 200.

Additional descriptions regarding FIGS. 4A-4K are provided below in reference to method 500 described with respect to FIG. 5.

FIG. 5 is a flow diagram of an exemplary method 500 for controlling environmental parameters of an area, in accordance with some embodiments. In some embodiments method 500 is performed at a computer system (e.g., computer system 152) and/or an area (e.g., area 200, a platform, a vehicle, an interior of a vehicle, a cabin of a vehicle, and/or a portion thereof). In some embodiments, method 300 is governed by instructions that are stored in a non-transitory (or transitory) computer-readable storage medium and that are executed by one or more processors of a computer system (e.g., 152 and/or 204) and/or an area (e.g., a platform, a vehicle, and/or area 200), such as the one or more processors 103 of system 100. Some operations in method 500 are, optionally, combined and/or the order of some operations is, optionally, changed.

In some embodiments, according to method 500, a computer system (e.g., 152, 202, 204, and/or 404) displays (502) (e.g., via a display device and/or a display component of the computer system), a set of one or more environmental control elements (e.g., 216a-216d) (e.g., a user interface element, a user-interactive user interface element, a button, a selectable icon, and/or an affordance). In some embodiments, the set of one or more environmental control elements are displayed in a user interface of an application that includes information and/or controls for an area (e.g., a vehicle). The computer system detects (504) (e.g., via one or more input devices such as 206, touch-sensitive surface(s) 115, input device(s) 158, a mouse, and/or a button) an input (e.g., 250b, 450a, 450b, 450c, and/or 450d) (e.g., a touch gesture on a touch-sensitive surface, an air gesture, a voice command, a button press, and/or other selection input) that includes selection of a first environmental control element of the set of one or more environmental control elements. In response to detecting the input that includes selection of the first environmental control element, the computer system sets (506) a respective environmental parameter for a respective location (e.g., 400a or 400b) (e.g., seat, section, portion, and/or passenger location) of (e.g., within) an area (e.g., area 200, a platform, a vehicle, an interior of a vehicle, a cabin of a vehicle, and/or a portion thereof) (e.g., an interior and/or cabin of the area), including: in accordance with a determination that the computer system is located at a first location (e.g., 400a and/or a first seat) relative to (e.g., within) the area, the computer system sets (508) the respective environmental parameter (e.g., temperature, temperature mode (such as air conditioning on or off or heat on or off), air temperature, seat temperature, fan speed, and/or fan mode) for the first location (e.g., 400a) (e.g., without setting and/or changing the first environmental parameter at a second location); and in accordance with a determination that the computer system is located at a second location (e.g., 400b and/or a second seat), different from the first location, relative to (e.g., within) the area, the computer system sets (510) the respective environmental parameter for the second location (e.g., 400b) (e.g., set the environmental parameter at the second location instead of the first location) (e.g., the environmental parameter is set for the location at which the computer system is located) (e.g., without setting and/or changing the first environmental parameter at the first location).

In some embodiments, setting the respective environmental parameter for the respective location includes setting the respective environmental parameter for the respective location without setting the respective environmental parameter for a different location of the area (e.g., without changing an environmental parameter for any other location of the area; set the environmental parameter only for the respective location; set the respective environmental parameter for the first location without setting the environmental parameter for the second location; and/or set the respective environmental parameter for the second location without setting the environmental parameter for the first location) (e.g., as described with reference to FIGS. 4C, 4E, and 4G).

In some embodiments, while the computer system is at a third location (e.g., 400a or 400b) of the area that is different from the respective location, the computer system detects (e.g., via one or more input devices) an input (e.g., 250b, 450a, 450b, 450c, and/or 450d) (e.g., a touch gesture on a touch-sensitive surface, an air gesture, a voice command, a button press, and/or other selection input) that includes selection of the first environmental control element of the set of one or more environmental control elements; and in response to detecting the input that includes selection of the first environmental control element, the computer system sets the respective environmental parameter for the third location (e.g., a user can use the same input, user interface, and/or control element to control the same environmental parameter while at different locations of the area).

In some embodiments, while the respective environmental condition is set for the respective location, the computer system detects a change in position of the computer system (or, in some embodiments, a user associated with the computer system) from the respective location to a new location of the area (e.g., from 400a to 400b as shown in FIGS. 4C-4D); and in response to detecting the change in position of the computer system from the respective location to the new location, the computer system sets (e.g., automatically and/or without user input) the respective environmental parameter for the new location (e.g., sets location 400b to state S4 in FIG. 4D).

In some embodiments, the computer system detects that the computer system (or, in some embodiments, a user associated with the computer system) has entered the area (and, in some embodiments, that the computer system is located at an initial location in the area) (e.g., user 210 enters area 200 in FIG. 4B); and in response to detecting that the computer system has entered the area, the computer system sets (e.g., automatically and/or without user input) an environmental state for a location of the computer system (or, in some embodiments, a user associated with the computer system) in the area (e.g., sets location 400a to state S3). In some embodiments, the environmental state is based on a user associated with (e.g., that is logged into) the computer system (e.g., the area automatically sets the environmental state of the location of the computer system to a state that is associated with the user of the computer system) (e.g., state S3 in FIG. 4B is associated with, specific to, and/or customized to user 210). For example, setting the environmental state for the location of the computer system in the area in response to detecting that the computer system has entered the area includes: in accordance with a determination that the computer system is associated with a first user, setting the environmental state to a first set of environmental parameters (e.g., a set of environmental parameters that are associated with, customized for, and/or selected by the first user); and in accordance with a determination that the computer system is associated with a second user that is different from the first user, setting the environmental state to a second set of environmental parameters that is different from the first set of environmental parameters (e.g., a set of environmental parameters that are associated with, customized for, and/or selected by the second user).

In some embodiments, the respective environmental parameter includes one or more of air temperature (e.g., corresponding to 216a), fan speed (e.g., corresponding to 216tc), or seat temperature (e.g., corresponding to 216d).

In some embodiments, aspects/operations of methods 300 and/or 500 may be interchanged, substituted, and/or added between these methods.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A computer system, comprising:
one or more processors; and
memory storing one or more programs configured to be executed by the one or more processors, the one or more programs including instructions for:
detecting that a set of one or more proximity conditions is satisfied, wherein the set of one or more proximity conditions includes a distance condition that is satisfied when a distance between a computer system and an area is determined to satisfy a threshold distance;
in response to detecting that the set of one or more proximity conditions is satisfied, displaying a prompt to open an area control application that is configured to perform one or more functions associated with the area;
while displaying the prompt to open the area control application, detecting an input that includes selection of the prompt;
in response to detecting the input that includes selection of the prompt, displaying a user interface of the area control application, including displaying, in the user interface of the area control application, one or more selectable elements including an area control element;
detecting an input that includes selection of the area control element; and
in response to detecting the input that includes selection of the area control element, requesting that the area perform an operation corresponding to the area control element.

2. The computer system of claim 1, wherein the one or more programs further include instructions for:
in accordance with a determination that the computer system is within the area, executing the area control application as a background process on the computer system.

3. The computer system of claim 1, wherein displaying the prompt includes:
in accordance with a determination that the computer system is inside the area, displaying the prompt in a dynamic area of a display of the computer system.

4. The computer system of claim 1, wherein the one or more programs further include instructions for:
ceasing display of the user interface of the area control application;
while the user interface of the area control application is not displayed, displaying an interactive area control user interface element that includes one or more selectable control elements;
detecting a user input that includes selection of a first control element of the one or more selectable control elements; and
in response to detecting selection of the first control element, cause the computer system to request the area to perform an operation corresponding to the first control element.

5. The computer system of claim 4, wherein displaying the interactive area control user interface element includes displaying the interactive area control user interface element having content that is based on a context.

6. The computer system of claim 5, wherein displaying the interactive area control user interface element includes:
in accordance with a determination that the computer system is inside the area, displaying the interactive area control user interface element having a first set of one or more selectable control elements.

7. The computer system of claim 5, wherein displaying the interactive area control user interface element includes:
in accordance with a determination that the computer system is not inside the area, displaying the interactive area control user interface element having a second set of one or more selectable control elements.

8. The computer system of claim 1, wherein the set of one or more proximity conditions does not require the computer system to have an account associated with the area.

9. The computer system of claim 1, wherein the set of one or more proximity conditions does not require the computer system to have previously performed a configuration associated with the area.

10. The computer system of claim 1, wherein the operation corresponding to the area control element includes controlling an environment control parameter of the area.

11. The computer system of claim 1, wherein the operation corresponding to the area control element includes controlling a media parameter for the area.

12. The computer system of claim 1, wherein the operation corresponding to the area control element includes controlling a destination parameter for the area.

13. The computer system of claim 1, wherein the operation corresponding to the area control element includes editing a queue associated with the area.

14. The computer system of claim 1, wherein the one or more programs further include instructions for:
detecting an input that includes selection of a user interface setting for the user interface of the area,
wherein displaying the user interface of the area control application includes displaying the user interface of the area control application according to the user interface setting.

15. A non-transitory computer-readable storage medium storing one or more programs configured to be executed by one or more processors of a computer system, the one or more programs including instructions for:
detecting that a set of one or more proximity conditions is satisfied, wherein the set of one or more proximity conditions includes a distance condition that is satisfied when a distance between a computer system and an area is determined to satisfy a threshold distance;
in response to detecting that the set of one or more proximity conditions is satisfied, displaying a prompt to open an area control application that is configured to perform one or more functions associated with the area;
while displaying the prompt to open the area control application, detecting an input that includes selection of the prompt;
in response to detecting the input that includes selection of the prompt, displaying a user interface of the area control application, including displaying, in the user interface of the area control application, one or more selectable elements including an area control element;
detecting an input that includes selection of the area control element; and
in response to detecting the input that includes selection of the area control element, requesting that the area perform an operation corresponding to the area control element.

16. A method, comprising:
detecting that a set of one or more proximity conditions is satisfied, wherein the set of one or more proximity conditions includes a distance condition that is satisfied when a distance between a computer system and an area is determined to satisfy a threshold distance;
in response to detecting that the set of one or more proximity conditions is satisfied, displaying a prompt to open an area control application that is configured to perform one or more functions associated with the area;
while displaying the prompt to open the area control application, detecting an input that includes selection of the prompt;
in response to detecting the input that includes selection of the prompt, displaying a user interface of the area control application, including displaying, in the user interface of the area control application, one or more selectable elements including an area control element;
detecting an input that includes selection of the area control element; and
in response to detecting the input that includes selection of the area control element, requesting that the area perform an operation corresponding to the area control element.
